(19) United States
(12) Patent Application Publication
(10) Pub. No.: US 2014/0267747 A1
(43) Pub. Date: Sep. 18, 2014

(54) REAL-TIME SHARING OF INFORMATION CAPTURED FROM DIFFERENT VANTAGE POINTS IN A VENUE

(71) Applicant: INTERNATIONAL BUSINESS MACHINES CORPORATION, Armonk, NY (US)

(72) Inventors: Barry A. Kritt, Raleigh, NC (US); Sarbajit K. Rakshit, Kolkata (IN)

(73) Assignee: International Business Machines Corporation, Armonk, NY (US)

(21) Appl. No.: 13/845,008

(22) Filed: Mar. 17, 2013

(51) Int. Cl. H04N 7/18

(52) U.S. Cl. CPC H04N 7/181
USPC 348/159

(57) ABSTRACT

Real-time sharing of imagery captured from different vantage points at a venue is provided. At least one of images and video are captured at different locations and different vantage points in a venue during an event. The images or video are temporarily stored on a server. A spectator requests at least one of images or video from a location and vantage point. If images or video captured at the requested location or vantage point are stored on the server, then a list of the images or video are displayed on a mobile imaging device operated by the spectator requesting the images or video. The spectator selects an image or video from the list, and the image or video is displayed on the mobile device.

### BACKGROUND

The present invention relates generally to temporary information sharing and, more specifically, to a system for temporarily gathering, storing, and sharing information, such as images and video captured during an event.

Today most sports stadiums, live entertainment facilities, convention centers, and similar entertainment venues, collectively referred to herein as “venues”, frequently utilize cameras positioned in different locations within the venue. These cameras are positioned to capture video or still images of an event occurring in the venue. An “event” as used herein may comprise any occurrence that may be viewed by spectators in a venue including entertainer performances, sporting events, and similar type events.

Large monitors are also positioned within the venue so audience, fans, or spectators at an event can view instant replays, close-ups of performers, advertisements, and other data related to the event or venue on the monitors. However, video and still images that are broadcasted remotely through satellite and cable television networks, or displayed on the monitors at the venue, and are limited to aspects provided the cameras positioned about the venue or broadcast to remote displays, such as on a television in the home of a viewer, one at a time from venue controlled media or broadcast media directors.

Spectators of an event occurring at the venue are limited to what they can physically see or capture on their personal camera or video recorder from their vantage point or view on the monitors. The spectator must either view the event from their assigned seat or location, or they can view video or still images of the event being displayed on one or more monitors in the venue, which are pre-selected by media directors and broadcasters for the remote viewing audience, as noted above. However, if the spectator desires to view the event from another vantage point within the venue or from a vantage point different from what is being displayed on the monitors in the venue, the spectator must physically move to the desired vantage point.

However, the spectator may not be able to access the desired vantage point for viewing the event due to various factors. For example, the spectator's ticket to the event my not provide them access to the desired vantage point. Additionally, as the spectator is physically maneuvering through the venue to the desired vantage point, the event may not be viewable and they may miss critical portions of the event.

Currently, there are proposed solutions that allegedly provide increased remote video viewing opportunities of activities that occur at entertainment venues. One exemplary solution includes capturing video-related data including multiple visual perspectives by cameras located at or near the activity and transmitting the data over wired or wireless networks to a server. The video-related data is processed and recorded for selective display by authorized, remote video display devices, that may include HDTV, set-top boxes, computers, and wireless handheld devices, that are also in wired or wireless communication with the server. Users and online communities can be registered with multimedia servers or a service and users can be authorized to access a server to provide video captured at an activity. Registered users can selectively retrieve video-related data captured at the activity for display by video display devices.

### BRIEF SUMMARY

In one general embodiment, a method that includes capturing images at different locations and from different vantage points in a venue during an event and storing the images on a server. The method continues with selecting a vantage point in the venue and determining if images captured at the selected location or vantage point are stored on the server. If images captured at the vantage point are stored on the server, then displaying a list of the images on a mobile device. The method then selects at least one image from the list and displays the image on the mobile device.

In another general embodiment a method includes capturing at least one of images and video at different locations and from different vantage points in a venue during an event, with at least a portion of the images or video captured using mobile imaging devices. The method continues with uploading the images or video to a server for temporary storage during the event, selecting at least one of a location and vantage point in the venue, and determining if images or video captured at the selected location or vantage point are stored on the server. If images or video captured at the selected location or vantage point are stored on the server, the method then displays a list of the images or video on a mobile device, selects at least one image or video from the list, and displays the image or video on the mobile device. if images or video captured at the selected location or vantage point are not stored on the server, the method then sends a request for capturing images or video at the selected location or vantage point.

In further general embodiment, a system that includes a venue for hosting an event, where the event viewable from a plurality of vantage points in the venue, and vouchers for spectators of the event, with each voucher including machine-readable optical code. The system also includes a plurality of mobile imaging devices, each mobile imaging device including a display capable of reading the optical code for associating a mobile imaging device with the voucher and for displaying images and video. The optical code invokes downloading of venue data to the mobile imaging device that includes spectator location data for identifying locations of mobile imaging devices determined by the associated voucher. The system further includes capturing at least one of images and video at a plurality of spectator locations and from different vantage points using a plurality of mobile imaging devices, such that images or video of the event are captured from a plurality of vantage points throughout the venue, and temporarily storing images or video on a server during the event. In the system, a spectator then requests at least one of images or video from a spectator location and vantage point. The system then determines if images or video captured at the selected spectator location or vantage point are stored on the server. If images or video captured at the requested spectator location or vantage point are stored on the server, the system then displays a list of the images or video on a mobile device of the spectator requesting the images or video, the spectator selects at least one image or video from the list, and displays the image or video on the display of their mobile imaging device. If images or video captured at the requested spectator location or vantage point are not stored on the server, then a request for capturing images or video to a spectator located proximate to the selected spectator location or vantage point is sent.

### BRIEF DESCRIPTION OF THE SEVERAL VIEWS OF THE DRAWINGS

FIG. 1 illustrates a simplified diagram of an exemplary embodiment of a system for temporarily gathering, storing, and sharing information, such as images and video captured during an event in accordance with an exemplary embodiment of the invention;

FIG. 2 illustrates is a diagram of an exemplary embodiment of a system for temporarily gathering, storing, and sharing information, such as images and video captured during an event showing a partial, fragmentary view of a venue;

FIG. 3 illustrates is a simplified block diagram of a remote mobile device in accordance with an embodiment of the invention;

FIG. 4 is a simplified diagram of a voucher in accordance with an exemplary embodiment of the invention; and

FIG. 5 is a flowchart showing an exemplary process for temporarily gathering, storing, and sharing information, such as images and video captured during an event in accordance with an exemplary embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

In one general embodiment, a method that includes capturing images at different locations and from different vantage points in a venue during an event and storing the images on a server. The method continues with selecting a vantage point in the venue and determining if images captured at the selected location or vantage point are stored on the server. If images captured at the vantage point are stored on the server, then displaying a list of the images on a mobile device. The method then selects at least one image from the list and displays the image on the mobile device.

In another general embodiment a method includes capturing at least one of images and video at different locations and from different vantage points in a venue during an event, with at least a portion of the images or video captured using mobile imaging devices. The method continues with uploading the images or video to a server for temporary storage during the event, selecting at least one of a location and vantage point in the venue, and determining if images or video captured at the selected location or vantage point are stored on the server. If images or video captured at the selected location or vantage point are stored on the server, the method then displays a list of the images or video on a mobile device, selects at least one image or video from the list, and displays the image or video on the mobile device. if images or video captured at the selected location or vantage point are not stored on the server, the method then sends a request for capturing images or video at the selected location or vantage point.

In further general embodiment, a system that includes a venue for hosting an event, where the event viewable from a plurality of vantage points in the venue, and vouchers for spectators of the event, with each voucher including machine-readable optical code. The system also includes a plurality of mobile imaging devices, each mobile imaging device including a display capable of reading the optical code for associating a mobile imaging device with the voucher and for displaying images and video. The optical code invokes downloading of venue data to the mobile imaging device that includes spectator location data for identifying locations of mobile imaging devices determined by the associated voucher. The system further includes capturing at least one of images and video at a plurality of spectator locations and from different vantage points using a plurality of mobile imaging devices, such that images or video of the event are captured from a plurality of vantage points throughout the venue, and temporarily storing images or video on a server during the event. In the system, a spectator then requests at least one of images or video from a spectator location and vantage point. The system then determines if images or video captured at the selected spectator location or vantage point are stored on the server. If images or video captured at the requested spectator location or vantage point are stored on the server, the system then displays a list of the images or video on a mobile device of the spectator requesting the images or video, the spectator selects at least one image or video from the list, and displays the image or video on the display of their mobile imaging device. If images or video captured at the requested spectator location or vantage point are not stored on the server, then a request for capturing images or video to a spectator located proximate to the selected spectator location or vantage point is sent.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. The computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

For purposes of describing the embodiments disclosed herein, two elements are considered to be coupled when one element is able to send an electrical signal to another element. The electrical signal may represent, for example but not limited to, data, operating commands, status information, or electrical power, or any combination of these electrical signals. A coupling may be implemented by wired or wireless connection means.

As illustrated in the Figures, there is shown generally at 100, an exemplary embodiment of a system for temporarily gathering, storing, and sharing information, such as images and video captured during an event. In a general embodiment of the system 100, at least one of images and video are captured at different locations and from different vantage points and at different times in a venue and stored on a server for the duration of an event. One or more spectators may request either images or video, or both, from a vantage point in the venue and which were captured at a desired point in time. If images or video captured at the requested vantage point and time are stored on the server, then a list of the available images or video are displayed on a mobile device operated by the spectator requesting the images or video. The spectator selects an image or video from the list, and the image or video is displayed on the spectator's mobile imaging device. If no images or video captured at the requested vantage point and time are stored on the server, then the spectator may send a request to other users of the system 100 for images or video captured at the requested vantage point and time to be uploaded to the server. The spectator may then display the available images or video on their mobile device.

As illustrated in FIG. 1 and FIG. 2 of the drawings, in one general embodiment the system 100 includes a venue, shown generally at 102, for hosting an event 104, a server 106 for storing data, and more than one remote mobile device 108. In a preferred embodiment, the remote mobile devices 108 include both a display 110 and a camera 112 (best seen in FIG. 3) to allow the mobile device 108 to capture and display either images 114 or video, or both. Only images 114 are shown in the Figures, for ease of discussion only. As referred to herein, a spectator 116 comprises any individual who observes an event 104 occurring in the venue 102. Optionally, a spectator 116 may comprise a group of individuals observing an event 104 occurring in the venue 102 who share a mobile device 108.

In a general embodiment, the venue 102 may comprise any suitable place or location where events 104 are held. For example, the venue 102 may comprise a music venue suitable for events 104, such as concerts or musical performances and may vary substantially in size. In some embodiments, the venue 102 may be any suitable music venue ranging from an indoor concert hall to an outdoor arena. In other embodiments, the venue 102 may comprise an indoor or outdoor place or location where sporting events are held. Examples of sporting event venues include: indoor or outdoor sports stadiums, sports arenas, baseballs parks, ice hockey arenas, motorsport venues, multi-purpose stadiums and similar sports venues. In the embodiments, the venue 102 may comprise any suitable place or location where events 104 are held.

As defined herein, an event 104 may comprise any observable occurrence. An exemplary event 104 may comprise: a type of gathering a such as a marriage ceremony, a sports competition, a convention or conference, a happening such as an artistic performance, a musical performance, a media event that attracts coverage by media, or a corporate or business function, among many other well-known types of events 104. For ease of discussion only, the venue 102 discussed hereinafter, comprises a sports stadium and the event 104 occurring in the venue 102 comprises a sports event occurring on a field 118 of the venue 102.

In a general embodiment, the venue 102 is organized into several different sections 120, with each section 120 configured with one or more rows 122 of one or more seats 124, as illustrated in FIG. 2. The venue 102 may optionally comprise more than one level to provide spectators 116 different vantage points with which to view the event 104 and to provide increased audience capacity of the venue 102. An exemplary venue 102 may include a lowermost or field level 126, and an uppermost or grandstand level 128. One or more levels, such as a main level 130, may be situated between the field level 126 and grandstand level 128.

Additionally, broadcast cameras 132 may be positioned about the venue 102 to capture video or still images of an event 104 occurring in the venue 102. The broadcast cameras 132 may be in fixed locations in the venue 102 and may be controlled remotely in some embodiments. For example, a broadcast team for a television network (not shown) may control positioning and repositioning one or more of the broadcast cameras 132 for transmitting desired video and still images captured by the cameras 132 across a television network (not shown). Additionally, video and still images captured by the cameras 132 may also be displayed on monitors 134 in the venue 102.

As illustrated in FIG. 1 and FIG. 2, in some embodiments, a server 106 may be provided for storing images 114 or video of an event 104 captured in the venue 102. In a general embodiment, the server 106 may comprise a known computer server coupled to a network 136 of the venue 102. In some embodiments, the network 136 may comprise a Local Area Network (LAN) contained within the venue 102. In optional embodiments, the network 136 may comprise a LAN connected to external networks, such as the Internet 138. The server 106 may be either located within the venue 102 or located remotely, depending on the networking scheme of the server 106.

In a general embodiment, the server 106 includes a processor 140 for running a known operating system (not shown) and memory 142 for temporary data storage. The server 106 also includes a data storage system 144. In some embodiments, the data storage system 144 may comprise a plurality of storage devices, such as a known RAID system, providing terabytes of data storage. The processor 140 is connected to memory 142, which may comprise volatile data storage, via memory data and address lines 146 and to the data storage system 144 by data bus 148.

In some embodiments, both images 114 and/or video of an event 104 captured by spectators 116 and the broadcast cameras 132 during the event 104 may be stored on the sever 106 during the event. In alternative embodiments, only images 114 and/or video of the event 104 captured by spectators 116 during the event 104 are stored on the sever 106.

In some embodiments, images 114 and/or video of the event 104 captured by spectators 116 and the broadcast cameras 132 during the event 104 are deleted from the server 106 upon the conclusion of the event 104. In optional embodiments, either the images 114 and/or video of the event 104 captured by spectators 116 or the images 114 and/or video captured by the broadcast cameras 132 during the event 104 are deleted from the server 106 upon the conclusion of the event 104. In alternative embodiments, images 114 and/or video of the event 104 captured by either spectators 116 or the broadcast cameras 132 are deleted from the server 106 at some predetermined time after the conclusion of the event 104. In a preferred embodiment, at least one of the images 114 and/or video of the event 104 captured by either spectators 116 or the broadcast cameras 132 are deleted from the server 106 after the conclusion of the event 104, to reduce the data stored on the server 106 and provide sufficient data storage space for images 114 and/or video from subsequent events 104.

As illustrated in FIGS. 1-3, and particularly to FIG. 3, in exemplary embodiments, one or more of remote mobile devices 108 may comprise a known mobile device such as a smartphone 108. In optional embodiments, the one or more of remote mobile devices 108 may comprise a mobile computing device, such as a known tablet computer 108T. In preferred embodiments, the mobile devices 108 may comprise suitable, known mobile devices such as smartphones 108 or tablet computers 108T that are capable of capturing and displaying either photos or video, or both and communicating with a network. In smartphone embodiments of the mobile device 108, the smartphone 108 is preferably capable of both telecommunications and wireless data transfer between the device 108 and a network, such as the LAN 136 and the Internet 138. In tablet embodiments of the mobile device 108T, the tablet 108T is preferably capable of wireless data transfer between the device 108 and a network, such as the LAN 136 and the Internet 138.

In the embodiments, the mobile device 108 includes a housing 150 that retains the display 110. Optionally, the display 110 may comprise a touchscreen display 110 to allow a user to input and manipulate data, as well as view data via the touchscreen 110. In further optional embodiments, the mobile device 108 may be configured with both the touchscreen display 110 and keyboard (not shown). In such an embodiment, the user my input and manipulate data using either or both the keyboard and touchscreen 110. Additionally, each remote mobile device 108 may include a home button 152 that is also retained in the housing 150. The home button 152 is provided for displaying a home menu (not shown) on the touchscreen 110, and may provide additional known functionalities for the mobile device 108.

As illustrated in FIG. 3, in general embodiments, each mobile device 108 includes a processor 154 for processing data, a memory 156, a communications module 158, and an on-board power source 160, such as a battery. In preferred embodiments, each mobile device 108 additionally includes both a camera 112 to allow the mobile device 108 to capture either images 114 or video, or both, and a display 110 for displaying images 114, video, and other data. In some embodiments, the processor 154 is connected to the memory 156 via memory data and address lines 162, to the communications module 158 by a data bus 164, to the camera 112 via data lines 166, and to the display 110 via data lines 168. The memory 156 may comprise both volatile and nonvolatile data storage, as is known.

In general embodiments, the communications module 158 provides data transmission and voice communications between the mobile device 108 and external networks. The communications module 158 may comprise a component of the processor 154 or may comprise stand-alone circuitry, as shown in FIG. 3. The communications module 158 is capable of wirelessly connecting the mobile device 108 to external networks, such as the LAN 136 and Internet 138. In an exemplary embodiment, the communications module 158 comprises a known Wi-Fi® transmitter and receiver which provides high-speed data transmission between the mobile device 108 and LAN 136 and/or Internet 138. Preferably, the communications module 158 provides data transmission rates sufficient to allow a user to browse websites and access other data on the LAN 136 and/or Internet 138.

In optional embodiments, the communications module 158 may be configured with a short-range component 170. The short-range component 170 facilitates short-range wireless data transmission for connection to the LAN 136, using known technologies such as Bluetooth®. Known telecommunications circuitry 172 may be provided in smartphone embodiments of the mobile device 108, for providing telecommunications functionality. In some embodiments, the telecommunications circuitry 172 may be coupled to the processor 154 and/or to the communications module 158, allowing the processor 154 to control the functions of the telecommunications circuitry 172, as is known in the art. Alternatively, the telecommunications circuitry 172 may be directly controlled by a user actuating the telecommunications circuitry 172 via the display 110. Often, the telecommunications circuitry 172 is controlled by both the processor 154 and by a user (not shown) of the mobile device 108.

An antenna 174 to facilitate transmission of radio frequency signals may be coupled to the telecommunications circuitry 172 and to the communications module 158. The antenna 174 is provided to facilitate transmission of radio frequency signals for both data and telecommunications transmissions.

In some embodiments, both data 180 and application software 182 may be stored in the memory 156. Application software 182 intended for use on mobile devices, such as smartphones 108 and tablets 108T, is known in the art as an “app”. An app 182 comprises software which is specifically written for mobile devices and is designed to perform specific tasks. The “app” abbreviation represents both the smaller program size and smaller scope of the application software 182. Examples of apps 182 include media players, for playing music and videos, and weather apps for displaying the current weather on the mobile device 108. One or more apps 182 are typically provided with the mobile device 108/108T and additional apps 182 may be purchased separately by a user.

In preferred embodiments, one such app 182 comprises a code scanner app 182SC for reading optical code, such as barcode or Quick Response Code 184 (shown in FIG. 4). Quick Response Code 184 is known in the art as a “QR” code and comprises a type of matrix barcode that is an optical, machine-readable label that consists of black modules that are arranged in a square pattern on a white background. The information encoded in the QR Code 184 may comprise one or more of four standardized types of data including: numeric, alphanumeric, byte, and binary, as known in the art. Typically, metadata from the QR Code 184 directs a browser app 182B on the mobile device 108 to a website. Once the browser app 182B is navigated to the desired website, information relevant to the QR Code 184 is displayed on the mobile device's display 110.

As illustrated in FIG. 3 and FIG. 4, in the embodiments, the code scanner app 182SC is invoked for reading a QR Code 184. Metadata contained in the QR Code 184 is read by the code scanner app 182SC which then invokes another app 182 on the mobile device 108. In some embodiments, the metadata read from the QR Code 184 may invoke an automatic download of information regarding the venue 102 to the mobile device 108. In some embodiments, the information regarding the venue 102 may be stored on the server 106 and downloaded therefrom. In alternative embodiments, the metadata read from the QR Code 184 may direct the browser app 182B of the mobile device 108 to a website that provides information regarding the venue 102. In an optional embodiment, the metadata read from the QR Code 184 may invoke a venue app 182V which provides information regarding the venue 102.

Referring now to FIG. 1 and FIG. 2, in the embodiments, information regarding the venue 102 may include a diagram 186 (shown as a two-dimensional diagram in FIG. 1), commonly referred to as a “seating chart”, of the venue 102, showing the various levels 126-130, sections 120, and seats 122 of the venue 102. Optionally, the seating chart 186 of the venue 102 may comprise a three-dimensional diagram and may provide graphical representation of a spectator's vantage point from a particular seat 124 in a particular section 120 of the venue 102, as is known.

Additional information regarding the venue 102 may include location of the broadcast cameras 132, exit information, vendors, emergency personnel, and other pertinent information regarding the venue 102. Once information regarding the venue 102, such as the seating chart 186, is displayed on the touchscreen display 110 of the spectator's mobile device 108, they may manipulate the seating chart 186 using the display 110. For example, the spectator 116 may pinch and drag to increase or decrease the magnification level, known in the art as “zoom in” and “zoom out” of the seating chart 186 displayed on the display 110. The spectator 116 may then select a seat 124 in desired section 120 of the venue 102. Once the seat 124 is selected, they may then view a graphical representation of the vantage point of the venue and field 118 from the selected seat 124.

As illustrated FIGS. 1, 2, and 4, if a spectator 116 desires to observe a particular event 104 occurring in the venue 102, they typically must first obtain a voucher 190 to gain entry into the venue 102 for the particular event 104. The voucher 190 may comprise a token, such as a piece of paper that the spectator 116 physically possesses and presents to personnel at the venue 102 who grant spectators 116 access to the venue 102 for the duration of the event 104, upon validation of the voucher 190. Alternatively, voucher 190 may be obtained electronically by the spectator 116 and displayed on the display 110 the mobile device 108 that the spectator 116 possesses. The voucher 190 typically grants the spectator 116 access to the venue 102 for the duration of the event 104 for observing, or in some instances participating in, the particular event 104. The voucher 190 may provide the spectator 116 access to any or all available sections 120 of the venue 102, or a particular section 120, or a particular seat 124 in a particular section 120 of the venue 102, depending on the venue 102 and type of event 104 occurring. Most frequently, the voucher 190 entitles the spectator 116 to a particular seat 124 in a particular section 120 of the venue 102 for the duration of the event 104.

In some embodiments, if a spectator 116 desires to observe a particular event 104 occurring in the venue 102, they typically obtain a voucher 190 to gain entry into the venue 102. The spectator 116 presents the voucher 190 to personnel or devices, such as a known QR code scanner (not shown), to gain entry into the venue 102 for the duration of the event 104. In optional embodiments, the voucher 190 may be an electronic voucher 190 with its QR Code 184 displayed on the display 110 of the spectator's mobile device 108. The QR code 184 on the voucher 190 is scanned by the scanner, which reads the metadata contained in the QR code 184 and displays information regarding the voucher 190 to an operator of the scanner. This information may include confirmation that the voucher 190 is indeed valid for the event 104 and venue location information to which the voucher 190 corresponds. The venue location information may include the section 120, row 122, and seat 124 to which the voucher 190 corresponds, thus indicating to the spectator 116 their assigned seat 124 for the event 104.

As illustrated in FIG. 2, in the embodiments, one or more seats 124 may be configured with an identification device 192. The identification device 192 may be provided to indicate the exact position of the seat 124 in the venue 102. In a preferred embodiment, the identification device 192 comprises a known Radio-frequency identification tag (RFID) that uses radio-frequency electromagnetic fields to transfer data from the RFID tag 192 attached to a seat 124, for the purposes of automatically identifying the location and position of the seat 124 in the venue 102.

Referring to the drawings Figures, and particularly to FIG. 5, a flowchart of an exemplary embodiment of a method for temporarily gathering, storing, and sharing information, such as images and video captured during an event in accordance with an exemplary embodiment of the invention, is shown generally at 200. The process 200 starts with start block 202. In process block 204, each spectator 116 presents a voucher 190 to personnel or devices, to gain entry into the venue 102 for the duration of the event 104. Spectators 116 procure vouchers 190 for the event 104 using well known methods. In the embodiments, the voucher 190 may comprise a token, such as a piece of paper that the spectator 116 physically possesses or may be electronic and displayed on the display 110 the mobile device 108 that the spectator 116 possesses. In process block 206, the voucher 190, is validated and the spectator 116 is granted access to the venue 102 for the duration of the event 104. In typical embodiments, the voucher 190 entitles the spectator 116 to a particular seat 124 in a particular row 122 of a section 120 of the venue 102 to which the voucher 190 corresponds.

The method 200 continues to process block 208, where the QR code 184 on the voucher 190 is scanned and the code scanner app 182SC is invoked to read the voucher's QR Code 184. In some embodiments, in process block 208 QR Code 184 read by the code scanner app 182SC which optionally invokes another app 182 on the mobile device 108 or may invoke an automatic download of information regarding the venue 102 to the mobile device 108, as previously discussed. In some embodiments, the QR Code 184 may invoke the venue app 182V, which displays and provides interaction with information regarding the venue 102, such as the seating chart 186 and other venue information. The spectator 116 may use the venue app 182V to navigate their way to their assigned seat 124, shown in process block 210.

In process block 212, an event 104 is underway in the venue 102 and spectators 116 may capture images 114 and/or video using the camera 112 of their mobile device 108. As images 114 and/or video are captured, they are automatically time-stamped by the mobile device 108, as known in the art. As images 114 and/or video are captured, spectators 116 may choose to upload the images 114 and/or video to the server 106, in process block 214. Images 114 and/or video captured by the broadcast cameras 132 may also be uploaded to the server 106 and are available to view by spectators 116. Spectators 116 may upload the images 114 and/or video to the server 106 using the venue app 182V on their mobile device 108 or, optionally, may use other known means. Additionally, as images 114 and/or video are uploaded to the server 106, data indicating the particular seat 124, row 122, and section 120 provided by the RFID tag 192 attached to the seat 124, is attached to the images 114 and/or video as they are uploaded.

In process block 216, a spectator 116 may desire to view a particular portion of the event 104 from a vantage point other than their own vantage point from their assigned seat 124. A spectator 116 may desire to view a particular portion of the event 104 from a vantage point other than their own vantage point at any time for the duration of the event 104. For example, a spectator 116 is sitting in the first seat 124, of the third row 122 of a section 120, such as section 3 (shown in FIG. 1 and FIG. 2) of the venue 102. They determine they want to view a particular portion of the event 104 from a vantage point other than theirs in the venue 102.

In process block 218, the spectator 116 ascertains from which vantage point they'd like to view the particular portion of the event 104. In some embodiments, they may view the venue's seating chart 186 to ascertain from which vantage point they'd like to view the particular portion of the event 104. For example, they may be viewing a sporting event and they desire to see a play that occurred on the end of the field 118 at a distance to their seat 124. They may view the seating chart 186 and determine that they want to view the desired play from a section 120, such as section 57 (shown in FIG. 1 and FIG. 2) of the venue 102. Optionally, they may also desire to view the play from a particular seat 124 in a particular section 122 in the desired section. They also know that the desired play occurred a two minutes in the past, so a particular time period in the recent past is selected in process block 220.

The spectator 116 may then navigate to the server 106 using the venue app 182V on their mobile device 108, or known means, in process block 222. In process block 224, the spectator 116 then inputs the desired section 120, such as section 57, of the venue 102 and any other information for viewing images 114 and/or video captured from the desired vantage point and time, so that they may view the desired portion of the event 104 from the desired vantage point and time.

In decision block 226 it is determined if images 114 and/or video images 114 and/or video captured from the desired vantage point and time are uploaded to the server 106. If images 114 and/or video captured from the desired vantage point and time are uploaded to the server 106, then a listing 196 of images 114 (shown in FIG. 1) and/or video captured from the desired vantage point and time are displayed on the display 110 of the spectator's mobile device 108, in process block 228. In process block 230, the spectator 116 may then scroll through the listing 196, select an image 114 or video, and then display the image 114 or video on the display 110 of their mobile device 108.

In decision block 232 the spectator 116 determines if they want to view an additional image 114 or video from captured from the desired vantage point and time. If the spectator 116 determines they want to view an additional image 114 or video from captured from the desired vantage point and time, then the process returns to decision block 226, where it is determined if images 114 and/or video images 114 and/or video captured from the desired vantage point and time are uploaded to the server 106.

If the spectator 116 determines they do not want to view an additional image 114 or video, then the method 200 continues to process block 234. If the spectator 116 determines they want to view an additional image 114 or video from captured from a different vantage point or time or both, the process returns to decision block 226, where it is determined if images 114 and/or video images 114 and/or video captured from the desired vantage point and time are uploaded to the server 106.

Returning to decision block 226, if it is determined images 114 and/or video images 114 and/or video captured from the desired vantage point and time are not uploaded to the server 106, then the spectator 116 sends a request to the system 100 for images 114 and/or video taken from the desired vantage point and time to be uploaded to the server 106, in process block 236. In process block 238, one or more spectators 116 located in the desired section 120 may receive the request. The request may specify seat 124 and row 122 in optional embodiments. In process block 240, a one or more spectators 116 located in the desired section 120 that have captured images 114 and/or video from the desired vantage point and at the desired time, they may then upload the desired images 114 and/or video to the server 106. The method 200 then continues to process block 234, where the event 104 concludes. In process block 242, images 114 and/or video of the event 104 captured by spectators 116 and the broadcast cameras 132 during the event 104 are deleted from the server 106 upon the conclusion of the event 104, as discussed previously. In optional embodiments, images 114 and/or video of the event 104 captured by either spectators 116 or broadcast cameras 132 are deleted from the server 106 at some predetermined time after the conclusion of the event 104. In a preferred embodiment, at least one of the images 114 and/or video of the event 104 captured by either spectators 116 or the broadcast cameras 132 are deleted from the server 106 after the conclusion of the event 104, to reduce the data stored on the server 106 and provide sufficient data storage space for images 114 and/or video from subsequent events 104. The method 200 then ends at end block 244.

Those skilled in the art will appreciate that various adaptations and modifications can be configured without departing from the scope and spirit of the embodiments described herein. Therefore, it is to be understood that, within the scope of the appended claims, the embodiments of the invention may be practiced other than as specifically described herein.

What is claimed is:

1. A method comprising:
capturing images at different locations and from different vantage points in a venue during an event;
storing the images on a server;
selecting a vantage point in the venue;
determining if images captured at the vantage point are stored on the server;
if images captured at the vantage point are stored on the server, then displaying a list of the images on a mobile device;
selecting at least one image from the list; and
displaying the image on the mobile device.

2. The method of claim 1, further comprising:
selecting a time period during the event;
determining if images captured at the vantage point and during the selected time period are stored on the server;
if images are stored on the server, then displaying a list of the images on a mobile device;
selecting at least one image from the list of images; and
displaying the image on the mobile device.

3. The method of claim 1, further comprising:
capturing video at different locations and from different vantage points in the venue during the event;
storing video on the server;
selecting a vantage point in the venue;
determining if video captured at the selected vantage point is stored on the server;
if video captured at the selected vantage point is stored on the server, then displaying a listing of at least one video on a mobile device;
selecting at least one video from the list; and
displaying the video on the mobile device.

4. The method of claim 3, wherein images or video are captured by a mobile imaging device.

5. The method of claim 3, wherein images or video are captured by a fixed imaging device of the venue.

6. The method of claim 3, further comprising:
uploading location information with the images or video uploaded to the server, the location information indicating the location and vantage point in the venue where the image or video was captured.

7. A method comprising:
capturing at least one of images and video at different locations and from different vantage points in a venue during an event, at least a portion of the images or video captured using mobile imaging devices;
uploading the images or video to a server for temporary storage during the event;
selecting at least one of a location and vantage point in the venue;
determining if images or video captured at the selected location or vantage point are stored on the server;
if images or video captured at the selected location or vantage point are stored on the server, then:
displaying a list of the images or video on a mobile device;
selecting at least one image or video from the list; and
displaying the image or video on the mobile device; and
if images or video captured at the selected location or vantage point are not stored on the server, then:
sending a request for capturing images or video at the selected location or vantage point.

8. The method of claim 7, further comprising:
selecting a time period during the event;
determining if images or video captured at the selected location or vantage point and during the selected time period are stored on the server;
if images or video are stored on the server, then displaying a list of the images or videos on a mobile device;
selecting at least one image or video from the list; and
displaying the image or video on the mobile device.

9. The method of claim 7, wherein images or video are captured by at least one of a mobile imaging device and a fixed imaging device.

10. The method of claim 7, further comprising:
images or video uploaded to the server during the event are removed from the server when the event ends.

11. The method of claim 7, further comprising:
providing a plurality of identification devices positioned at different locations in the venue, each identification device identifying a location of a mobile imaging device proximate to the identification device and generating location information.

12. The method of claim 11, further comprising:
uploading location information with the images or video uploaded to the server, the location information indicating the location and vantage point in the venue where the image or video was captured.

13. A system comprising:
a venue for hosting an event, the event viewable from a plurality of vantage points in the venue;
vouchers for spectators of the event, each voucher including machine-readable optical code;
a plurality of mobile imaging devices, each mobile imaging device including a display capable of reading the optical code for associating a mobile imaging device with the voucher and for displaying images and video, the optical code invoking downloading of venue data to the mobile imaging device that includes spectator location data for identifying locations of mobile imaging devices determined by the associated voucher;
capturing at least one of images and video at a plurality of spectator locations and from different vantage points using a plurality of mobile imaging devices, such that images or video of the event are captured from a plurality of vantage points throughout the venue;
temporarily storing images or video on a server during the event;
requesting at least one of images or video from a spectator location and vantage point;
determining if images or video captured at the selected spectator location or vantage point are stored on the server;
if images or video captured at the requested spectator location or vantage point are stored on the server, then:
displaying a list of the images or video on a mobile device of a spectator requesting the images or video, the spectator selecting at least one image or video from the list and displaying the image or video on the display of the mobile imaging device; and
if images or video captured at the requested spectator location or vantage point are not stored on the server, then:
sending a request for capturing images or video to a spectator located proximate to the selected spectator location or vantage point.

14. The system of claim 13, further comprising:
selecting a time period during the event;
determining if images or video captured at the requested location or vantage point and during the selected time period are stored on the server;
if images or video are stored on the server, then displaying a list of the images or videos on the mobile imaging device;
selecting at least one image or video from the list; and
displaying the image or video on the mobile device.

15. The system of claim 13, wherein images or video are captured by at least one of a fixed imaging device and mobile imaging device.

16. The system of claim 15, wherein the mobile imaging device comprises one of a smartphone, a tablet computing device, and a digital camera.

17. The system of claim 13, wherein images or video uploaded to the server during the event are removed from the server when the event terminates.

18. The system of claim 13, further comprising:
providing a plurality of identification devices positioned at different locations in the venue, each identification device identifying a location of a mobile device proximate to the identification device and generating location information.

19. The system of claim 13, further comprising:
uploading location information with the images or video uploaded to the server, the location information indicating the location and vantage point in the venue where the image or video was captured.
